(19) United States
(12) Patent Application Publication
(10) Pub. No.: US 2021/0224776 A1
(43) Pub. Date: Jul. 22, 2021

(54) BLOCKCHAIN-BASED ENTITLEMENT SERVICE

(71) Applicant: Schlumberger Technology Corporation, Sugar Land, TX (US)

(72) Inventors: Akshay HUNDIA, Houston, TX (US); Yuri DA SILVA FERREIRA, Pune (IN)

(21) Appl. No.: 17/250,056

(22) PCT Filed: May 15, 2019
(86) PCT No.: PCT/US2019/032354

§ 371 Date: Nov. 13, 2020

Related U.S. Application Data
(60) Provisional application No. 62/671,842, filed on May 15, 2018.

(51) Int. Cl. G06Q 20/22; G06F 16/21; H04L 9/06; G06Q 20/38

(52) U.S. Cl. CPC G06Q 20/223; G06F 16/219; H04L 2209/38; G06Q 20/3825; H04L 9/0643

(57) ABSTRACT

A method, apparatus, and program product utilize a distributed blockchain-based entitlement service of a cloud-based collaboration environment to grant or deny access to requested data based upon a contract represented in a blockchain managed by the blockchain-based entitlement service.

### CROSS-REFERENCE TO RELATED APPLICATION

This application claims priority to and the benefit of a US Provisional Application having Ser. No. 62/671,842, filed 15 May 2018, which is incorporated by reference herein.

### BACKGROUND

In the oil and gas industry, data is often generated from a variety of sources for clients that seek to remain privy to the latest trends in exploration and production technology. When data is not consistent or inaccessible, decisions made by such clients may not be the most well-informed, potentially resulting in production inefficiencies. Furthermore, enterprises of all types and sizes are coping with a wider variety of data at a very large scale, making it more difficult than ever to realize production insights. A company's proprietary data, however, is also a valuable asset that is desirably protected from unauthorized access.

In addition, oil and gas contracting can be complex, with lengthy contracts and agreements. A contract is often adjusted by a change of order that is generally tracked. Joint ventures are also very common in the industry and generally utilize a suite of complex agreements. Many contracts also contain audit clauses giving the parties the right to audit each other to make sure they are complying with the contract.

The oil and gas industry is also increasingly reliant on cloud-based solutions that provide access to data and applications from different devices, and that leverage cloud computing resources to process data in a computationally efficient and cost effective manner. Providing data access in cloud-based environments, however, may be complicated by the complex contractual arrangements between parties utilizing such environments as well as the desire to control the access to proprietary data while still providing ready access to authorized parties.

### SUMMARY

The embodiments disclosed herein provide a method, apparatus, and program product that utilize a distributed blockchain-based entitlement service of a cloud-based collaboration environment to grant or deny access to requested data based upon a contract represented in a blockchain managed by the blockchain-based entitlement service.

Therefore, consistent with one aspect of the invention, a method may include receiving a data access request at a cloud-based collaboration environment, and processing the data access request with a blockchain-based entitlement service resident in the cloud-based collaboration environment to grant or deny access to the requested data based upon a contract represented in a blockchain managed by the blockchain-based entitlement service.

In some embodiments, the blockchain-based entitlement service is distributed among a plurality of peer nodes in the cloud-based collaboration environment. Also, in some embodiments, the blockchain-based entitlement service is resident in a distributed blockchain framework.

Further, in some embodiments, the blockchain framework further includes a peer service configured to store transactions and digital contracts, the method further including executing a digital contract on a transaction using the peer service. Some embodiments may further include endorsing and committing transactions with the peer service. In some embodiments, the blockchain framework further includes an application software development kit functioning as a client library, the method further including performing transactions within the cloud-based collaboration environment using the application software development kit. In addition, in some embodiments, the blockchain framework further includes an ordering service configured to validate whether endorsed results have been received from a plurality of peer nodes and execute transactions once validation is complete. In some embodiments, the blockchain framework further includes a membership/entitlement service configured to authenticate, authorize and manage identities and channels.

Some embodiments may also include, in the blockchain-based entitlement service receiving a digitally signed transaction, forwarding the digitally signed transaction to a plurality of peer nodes, in each peer node, validating a digital signature, executing a digital contract setup for the transaction to generate simulation results, endorsing the simulation results and returning the endorsed simulation results, receiving the validated endorsed results from the plurality of peer nodes and sending the validated endorsed results to an ordering service, in the ordering service, validating the validated endorsed results, executing one or more transactions and generating a block, broadcasting the block to the plurality of peer nodes, and in each peer node, committing and adding the block to a blockchain of the peer node.

Some embodiments may also include an apparatus including at least one processing unit and program code configured upon execution by the at least one processing unit to perform any of the aforementioned operations, as well as a program product including a computer readable medium and program code stored on the computer readable medium and configured upon execution by at least one processing unit to perform any of the aforementioned operations.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described example embodiments of the invention. This summary is merely provided to introduce a selection of concepts that are further described below in the detailed description, and is not intended to identify key or essential features of the claimed subject matter, nor is it intended to be used as an aid in limiting the scope of the claimed subject matter.

### BRIEF DESCRIPTION OF THE DRAWINGS

FIGS. 1.1-1.4 illustrate simplified, schematic views of an oilfield having subterranean formation containing reservoir therein in accordance with implementations of various technologies and techniques described herein.

FIG. 2 illustrates a schematic view, partially in cross section of an oilfield having a plurality of data acquisition tools positioned at various locations along the oilfield for collecting data from the subterranean formations in accordance with one or more embodiments.

FIG. 3 illustrates a production system for performing one or more oilfield operations in accordance with one or more embodiments.

FIG. 4.1 illustrates a system in accordance with one or more embodiments.

FIG. 4.2 illustrates an example embodiment of the blockchain framework referenced in FIG. 4.1.

FIG. 4.3 illustrates an example embodiment of the blockchain referenced in FIG. 4.2.

FIG. 5 is a flowchart of an example sequence of operations for entering a transaction in the blockchain framework referenced in FIGS. 4.1-4.3.

FIG. 6 illustrates a data processing system including a cloud-based Exploration and Production (E&P) system in accordance with one or more embodiments.

FIG. 7 is a flowchart of an example sequence of operations for processing an access request using the blockchain-based entitlement service referenced in FIG. 6.

FIG. 8 illustrates an example computing system that can implement the various functions and features described herein.

FIG. 9 illustrates an example network that can implement the various functions and features described herein.

### DETAILED DESCRIPTION

The herein-described embodiments provide a method, apparatus, and program product that utilize a distributed blockchain-based entitlement service of a cloud-based collaboration environment to grant or deny access to requested data based upon a contract represented in a blockchain managed by the blockchain-based entitlement service.

Specific embodiments will now be described in detail with reference to the accompanying figures. Like elements in the various figures are denoted by like reference numerals for consistency.

In the following detailed description of embodiments, numerous specific details are set forth in order to provide a more thorough understanding of the embodiments. However, it will be apparent to one of ordinary skill in the art that various embodiments may be practiced without these specific details. In other instances, well-known features have not been described in detail to avoid unnecessarily complicating the description.

### Oilfield Operations

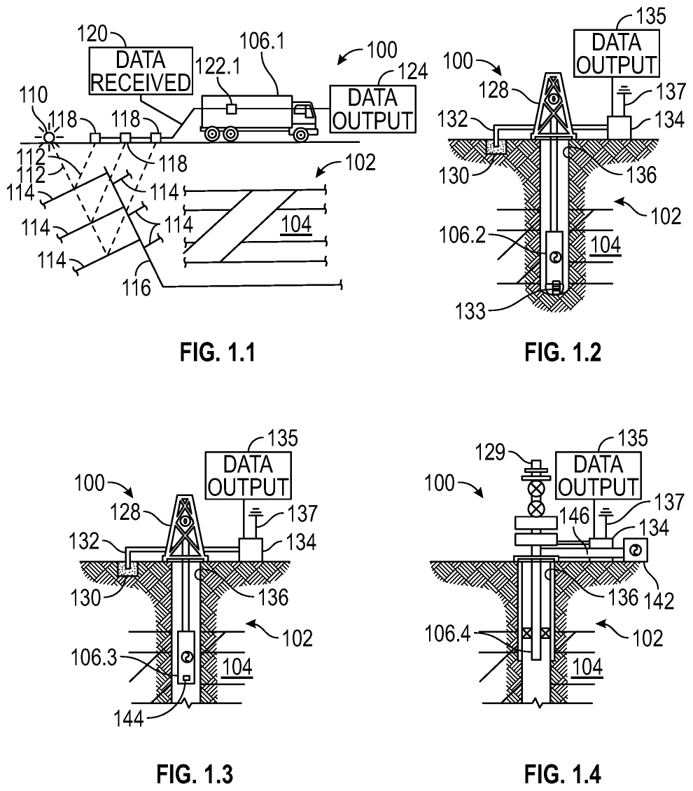

FIGS. 1.1-1.4 illustrate simplified, schematic views of an oilfield 100 having subterranean formation 102 containing reservoir 104 therein in accordance with implementations of various technologies and techniques described herein. FIG. 1.1 illustrates a survey operation being performed by a survey tool, such as seismic truck 106.1, to measure properties of the subterranean formation. The survey operation is a seismic survey operation for producing sound vibrations. In FIG. 1.1, one such sound vibration, sound vibration 112 generated by source 110, reflects off horizons 114 in earth formation 116. A set of sound vibrations is received by sensors, such as geophone-receivers 118, situated on the earth's surface. The data received 120 is provided as input data to a computer 122.1 of a seismic truck 106.1, and responsive to the input data, computer 122.1 generates seismic data output 124. This seismic data output may be stored, transmitted or further processed as desired, for example, by data reduction.

FIG. 1.2 illustrates a drilling operation being performed by drilling tools 106.2 suspended by rig 128 and advanced into subterranean formations 102 to form wellbore 136. Mud pit 130 is used to draw drilling mud into the drilling tools via flow line 132 for circulating drilling mud down through the drilling tools, then up wellbore 136 and back to the surface. The drilling mud is generally filtered and returned to the mud pit. A circulating system may be used for storing, controlling, or filtering the flowing drilling muds. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produces data output 135, which may then be stored or transmitted.

Sensors (S), such as gauges, may be positioned about oilfield 100 to collect data relating to various oilfield operations as described previously. As shown, sensor (S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors (S) may also be positioned in one or more locations in the circulating system.

Drilling tools 106.2 may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Generally, the wellbore is drilled according to a drilling plan that is established prior to drilling. The drilling plan generally sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected.

The data gathered by sensors (S) may be collected by surface unit 134 and/or other data collection sources for analysis or other processing. The data collected by sensors (S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize portions of the field operation, such as controlling drilling, weight on bit, pump rates, or other parameters. These adjustments may be made automatically based on computer protocol, and/or manually by an operator. In some cases, well plans may be adjusted to select optimum operating conditions, or to avoid problems.

FIG. 1.3 illustrates a wireline operation being performed by wireline tool 106.3 suspended by rig 128 and into wellbore 136 of FIG. 1.2. Wireline tool 106.3 is adapted for deployment into wellbore 136 for generating well logs, performing downhole tests and/or collecting samples. Wireline tool 106.3 may be used to provide another method and apparatus for performing a seismic survey operation. Wireline tool 106.3 may, for example, have an explosive, radioactive, electrical, or acoustic energy source 144 that sends and/or receives electrical signals to surrounding subterranean formations 102 and fluids therein. In general, wireline tool 106.3 may thereby collect acoustic data and/or image data for a subsurface volume associated with a wellbore.

Wireline tool 106.3 may be operatively connected to, for example, geophones 118 and a computer 122.1 of a seismic truck 106.1 of FIG. 1.1. Wireline tool 106.3 may also provide data to surface unit 134. Surface unit 134 may collect data generated during the wireline operation and may produce data output 135 that may be stored or transmitted. Wireline tool 106.3 may be positioned at various depths in the wellbore 136 to provide a survey or other information relating to the subterranean formation 102.

Sensors (S), such as gauges, may be positioned about oilfield 100 to collect data relating to various field operations as described previously. As shown, sensor S is positioned in wireline tool 106.3 to measure downhole parameters which relate to, for example porosity, permeability, fluid composition and/or other parameters of the field operation.

FIG. 1.4 illustrates a production operation being performed by production tool 106.4 deployed from a production unit or christmas tree 129 and into completed wellbore 136 for drawing fluid from the downhole reservoirs into surface facilities 142. The fluid flows from reservoir 104 through perforations in the casing (not shown) and into production tool 106.4 in wellbore 136 and to surface facilities 142 via gathering network 146.

Sensors (S), such as gauges, may be positioned about oilfield 100 to collect data relating to various field operations as described previously. As shown, the sensor (S) may be positioned in production tool 106.4 or associated equipment, such as christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 1.2-1.4 illustrate tools used to measure properties of an oilfield, it will be appreciated that the tools may be used in connection with non-oilfield operations, such as gas fields, mines, aquifers, storage, or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors (S) may be located at various positions along the wellbore and/or the monitoring tools to collect and/or monitor the desired data. Other sources of data may also be provided from offsite locations.

The field configurations of FIGS. 1.1-1.4 are intended to provide a brief description of an example of a field usable with oilfield application frameworks. Part, or all, of oilfield 100 may be on land, water, and/or sea. Also, while a single field measured at a single location is depicted, oilfield applications may be utilized with any combination of one or more oilfields, one or more processing facilities and one or more wellsites.

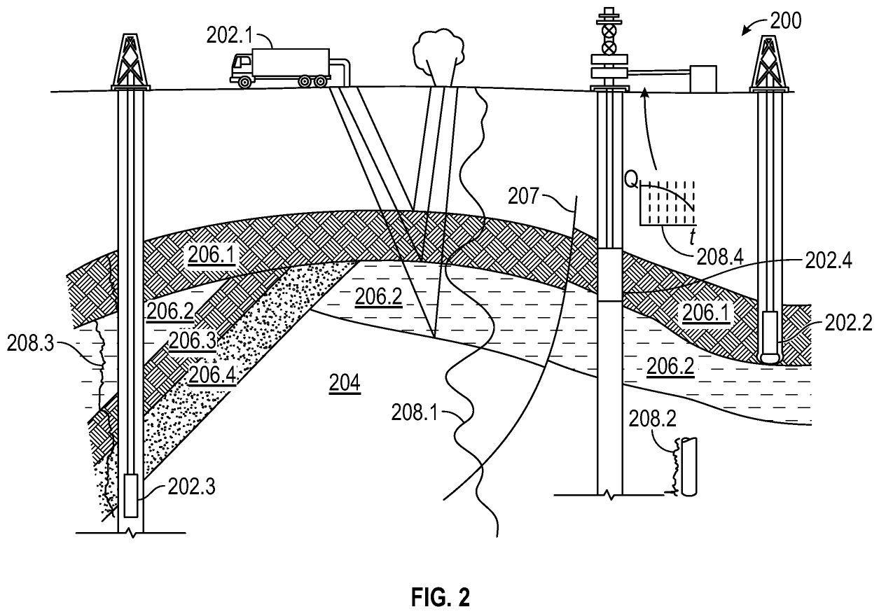

FIG. 2 illustrates a schematic view, partially in cross section of oilfield 200 having data acquisition tools 202.1, 202.2, 202.3 and 202.4 positioned at various locations along oilfield 200 for collecting data of subterranean formation 204 in accordance with implementations of various technologies and techniques described herein. Data acquisition tools 202.1-202.4 may be the same as data acquisition tools 106.1-106.4 of FIGS. 1.1-1.4, respectively, or others not depicted. As shown, data acquisition tools 202.1-202.4 generate data plots or measurements 208.1-208.4, respectively. These data plots are depicted along oilfield 200 to demonstrate the data generated by the various operations.

Data plots 208.1-208.3 are examples of static data plots that may be generated by data acquisition tools 202.1-202.3, respectively, however, it should be understood that data plots 208.1-208.3 may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208.1 is a seismic two-way response over a period of time. Static plot 208.2 is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208.3 is a logging trace that generally provides a resistivity or other measurement of the formation at various depths.

A production decline curve or graph 208.4 is a dynamic data plot of the fluid flow rate over time. The production decline curve generally provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 has a plurality of geological formations 206.1-206.4. As shown, this structure has several formations or layers, including a shale layer 206.1, a carbonate layer 206.2, a shale layer 206.3 and a sand layer 206.4. A fault 207 extends through the shale layer 206.1 and the carbonate layer 206.2. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, generally below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 2, may then be processed and/or evaluated. Generally, seismic data displayed in static data plot 208.1 from data acquisition tool 202.1 is used by a geophysicist to determine characteristics of the subterranean formations and features. The core data shown in static plot 208.2 and/or log data from well log 208.3 are generally used by a geologist to determine various characteristics of the subterranean formation. The production data from graph 208.4 is generally used by the reservoir engineer to determine fluid flow reservoir characteristics. The data analyzed by the geologist, geophysicist and the reservoir engineer may be analyzed using modeling techniques.

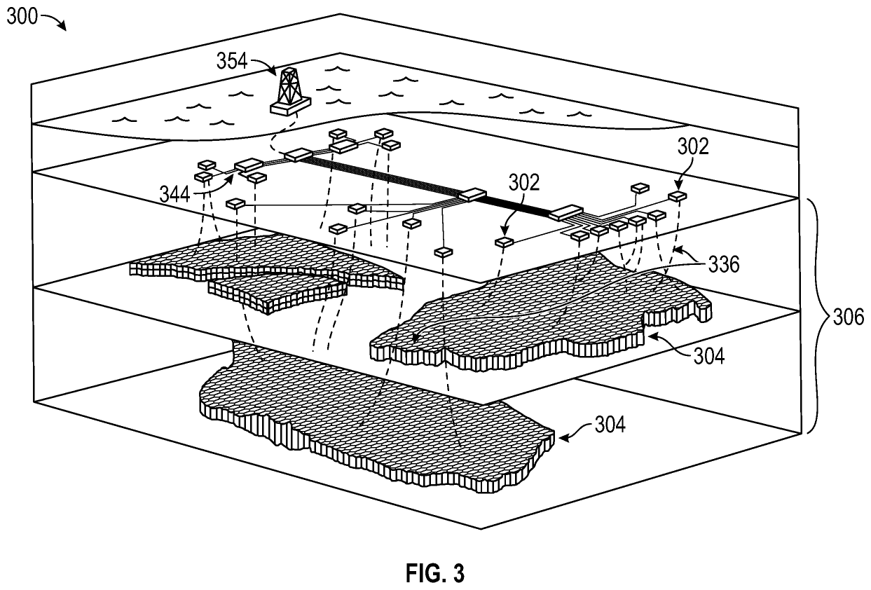

FIG. 3 illustrates an oilfield 300 for performing production operations in accordance with implementations of various technologies and techniques described herein. As shown, the oilfield has a plurality of wellsites 302 operatively connected to central processing facility 354. The oilfield configuration of FIG. 3 is not intended to limit the scope of the oilfield application system. Part, or all, of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

### Blockchain-Based Entitlement Service

Oil and gas contracting can be complex, with lengthy contracts and agreements. Contract may regularly be adjusted by changes of order, and desirably those changes are tracked. Joint ventures are also relatively common in the industry and generally utilize a suite of complex agreements. Many contracts also contain audit clauses giving the parties the right to audit one other to ensure they are complying with the contract.

Consistent with the trends in many other industries, the oil and gas industry is increasingly relying on cloud-based solutions for supporting exploration, production and other aspects of the oil and gas business. Furthermore, collaborative solutions are increasingly used to enable multiple individuals in the same organization or across different organizations to access and otherwise work with the same data, as well as perform various tasks using that data. For example, during early phase development of an oil field, various entities may collect scientific data from the oil field, while other entities may interpret that data based upon reservoir simulation and modeling to identify potential targets for recovering hydrocarbons from the oil field. Still other entities may utilize the data to develop well plans for use in drilling wells in the oil field, and yet other entities may utilize the data during production once production wells have been drilled and brought online.

In the illustrated embodiment, a cloud-based Exploration and Production (E&P) collaboration platform may be used throughout various phases associated with the development and production of an oil field. Within this collaboration platform, contracting may play a central role in the platform, and effectively guide data access to various users of the platform. Moreover, in the illustrated embodiment, contracts may be extended or modified from time to time, and tracking may be used to keep track of all updates made on various contracts. Such a collaboration platform may also support collaboration between different collections of entities, while still maintaining separation between the different collections of entities.

The tracking may be performed in the illustrated embodiments using a distributed database that maintains a continuously growing list (blockchain) of ordered contracts, where each contract is referred to as a block. Any new contract may be considered as new block, with every block containing a hash of the previous block in the blockchain, with its own hash calculated from the previous hash. Thus, if an entity tries to change any contract then the hash of that block will change, resulting in a change of the hashes of all the following blocks, and thereby resulting in an invalid blockchain. The validation (by a program) of the blockchain may be performed by each participating node, thereby facilitating detection of any tampering of data.

The illustrated embodiments may also leverage a distributed infrastructure, referred to herein as a blockchain-based entitlement service, to enable contract management as well as data entitlement, authentication and authorization, thereby reducing additional infrastructure cost and time to implement. In the illustrated embodiment, for example, contract management may not only manage and secure contracts but also enable “If-Then” premises, e.g., if a user's contract is not expired then allow access to the data. Notifications of unwanted or unauthorized activities may also be enabled in some embodiments.

In some embodiments, for example, a blockchain-based entitlement service consistent with the invention may be implemented in part using an application software development kit (SDK) and server-side service that validate whether an application user has access to a particular record/resource/data as per a contract. In some embodiments, the service may leverage a standardized blockchain technology framework, e.g., the Hyperledger Fabric framework available through the Linux Foundation or another suitable framework, to create and execute digital contracts. In some embodiments, such a standardized framework may be customized for creating and executing digital contracts within a cloud-based E&P collaboration system and for integrating with existing oil and gas-related services within the system. A standardized framework may be extended and leveraged to manage the authorization and authentication of the peer nodes involved.

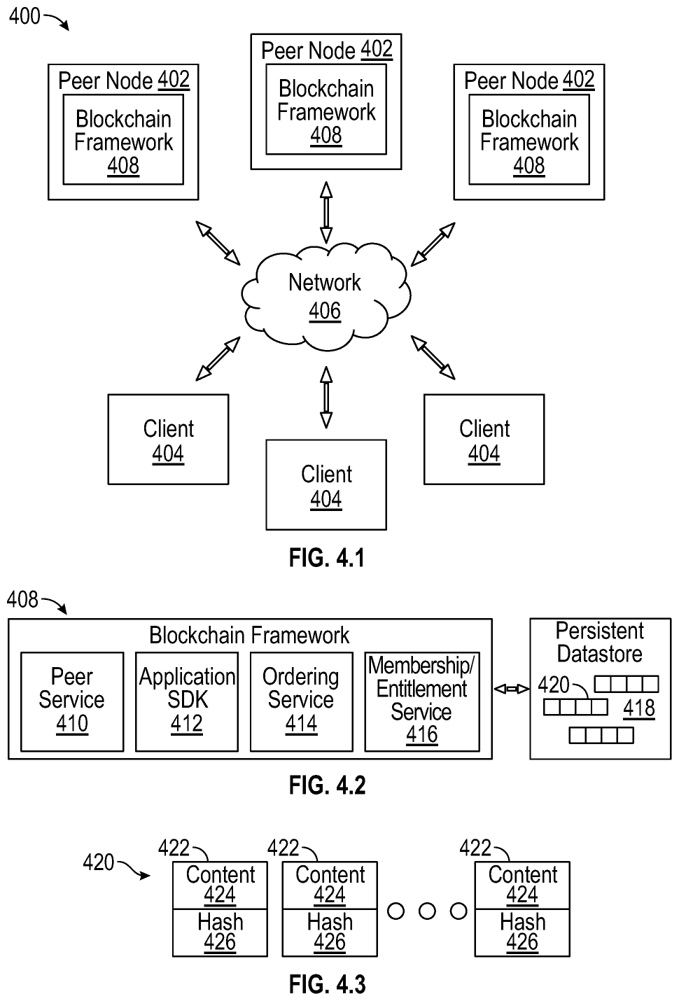

As illustrated in FIG. 4.1, in some embodiments, a blockchain-based entitlement service 400 may be implemented utilizing a plurality of peer nodes 402 that are accessible by a plurality of clients 404 through one or more networks 406. A blockchain framework 408, e.g., a blockchain framework based upon the Hyperledger Fabric framework, may be resident in each peer node 402 to maintain and execute digital contracts. The peer nodes 402 in some embodiments may be managed by an cloud-based E&P collaboration system, and each client 404 in some embodiments may have a few dedicated peer nodes 402 configured to store contracts related to a particular entity. Each peer node 402 may also be leveraged to store data, and based on contract details a private subnet (e.g., a Hyperledger Fabric channel) may be setup between associated peer nodes in order to enable a private and secured communication.

As illustrated in FIG. 4.2, in some embodiments blockchain framework 408 may incorporate on each peer node instances of a peer service 410, application SDK 412, ordering service 414 and membership/entitlement service 416 to establish distributed legal compliance within a standardized blockchain framework. Framework 408 may have access to a persistent datastore 418 including one or more blockchains 420. As illustrated in FIG. 4.3, each blockchain 420 may include a plurality of blocks 422, with each block 422 including content 424 and a hash 426. Content 424, for example, may include contract data, transaction data, etc.

Peer service 410 may be configured as a service that stores transactions in the form of cryptographically hashed blocks, as well as storing digital contracts. Each peer service instance may also be responsible for executing a digital contract on transactions to generate simulated results. Once the peer service validates transactions the peer service may endorse those transactions by signing them. Peer service instances may be connected to one another over a network subnet referred to herein as a channel. Peer service instances may also function as committers, e.g., to commit transactions to a blockchain once a new block is received from ordering service 414. In some embodiments, peer service 410 may be implemented as a service running on a cluster such as a Kubernetes cluster, although the invention is not so limited.

Application SDK 412 may function as a client library for developers that may be leveraged in order to perform transactions within the cloud-based E&P collaboration system. Application SDK 412 may also in some embodiments implement various cryptographic algorithms for use in signing transactions on an application's behalf.

Ordering Service 414 may be implemented in some embodiments as an independent RESTful service, e.g., running on a Kubernetes cluster, although the invention is not so limited. The ordering service may be used to validate whether it has received endorsed results from all involved peers in the peer node, and further may be used to execute transactions once in a FIFO manner once validation is completed. Thereafter, once the execution of a transaction is complete, the response may be sent back to application SDK 412 and a new block may be generated using a cryptographic hash. This newly generated block may then be broadcast to all peer nodes in the channel for commit.

Membership/Entitlement service 416 may also be configured in some embodiments as a service running on a Kubernetes cluster, although the invention is not so limited. Service 415 may be used to authenticate, authorize and manage identities and channels. Every peer and application may enroll itself to the membership service, and in some embodiments, multiple membership services may run to reduce the risk of single point of failure.

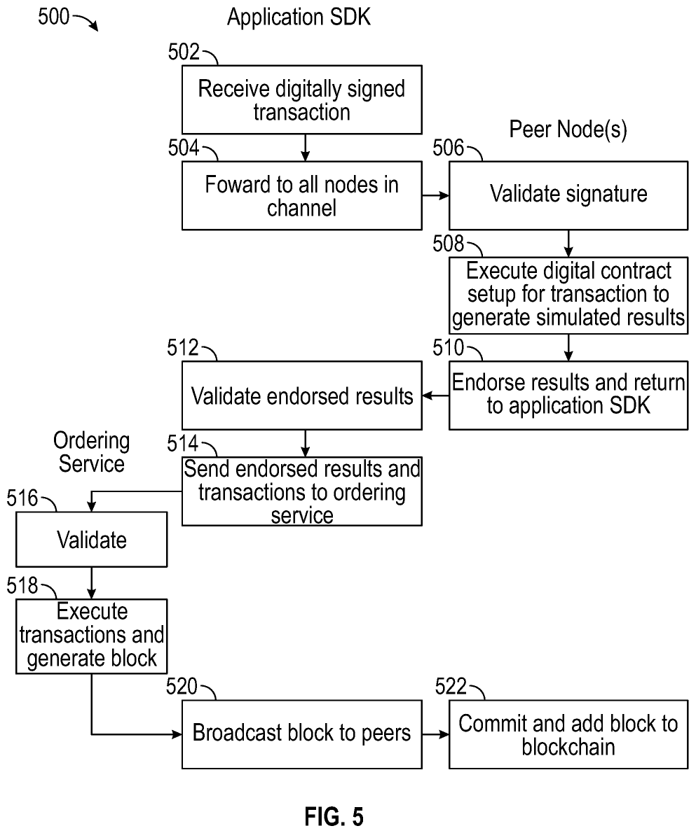

Now turning to FIG. 5, an example sequence 500 of operations suitable for processing transactions with blockchain framework 408 is illustrated in greater detail. In particular, whenever a new transaction is generated by the application SDK it may be digitally signed by an application (block 502) and forwarded to all peer nodes in the associated channel (block 504). The peer nodes may then validate the signature (block 506) and execute a digital contract setup for that transaction to generate simulated results (block 508). Each node may then generate the result and digitally sign it, which is referred to herein as endorsement (block 510). The endorsed results are then sent back to the application SDK, which validates whether each response has come from a peer node on the channel or not, as well as compares the simulated results received from all the peer nodes (block 512). Once the validation passes then the endorsed simulated results along with the transactions are sent to the ordering service (block 514), where the ordering service validates the endorsed results by confirming that the endorsed results have been received from all of the peer nodes in the channel or not (block 516). Once validated, the ordering services executes the transactions and generates a block using a cryptographic hash from the transactions (block 518). The newly generated block is then broadcast to all the peers in the channel to commit (block 520). Each peer node then commits and adds the new block to its respective blockchain (block 522).

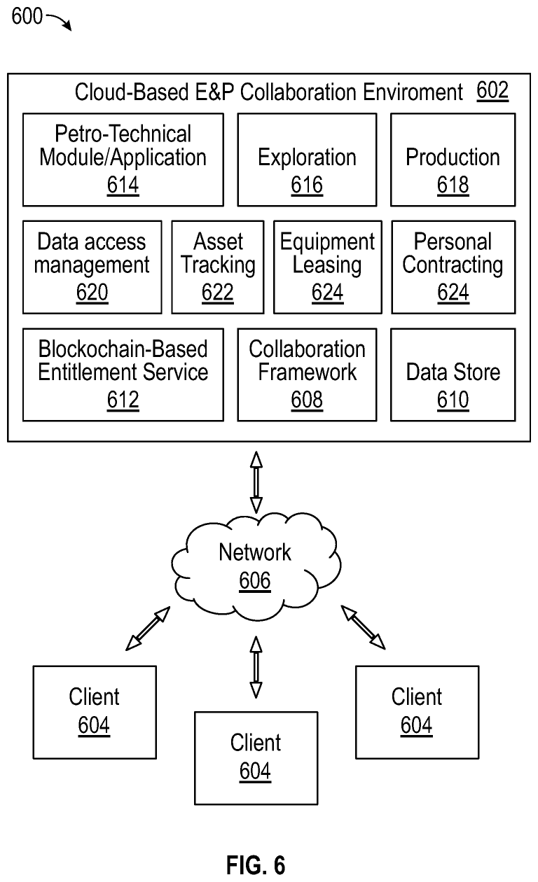

As shown by data processing system 600 in FIG. 6, blockchain-based entitlement consistent with the invention may be implemented in some embodiments within a cloud-based E&P collaboration environment 602 that is accessible by various clients 604 over one or more networks 606. Environment 602 may include a collaboration framework 608, e.g., based upon the DELFI collaboration framework available from Schlumberger, Ltd. or its affiliates, and which may maintain data for various entities in a data store 610. A blockchain-based entitlement service 612 may also be resident in environment 602 to provide blockchain-based entitlement on behalf of various applications and/or modules resident in the environment, generically illustrated by petro-technical module/application 614.

The applications that may be supported by the herein-described framework within the oil and gas industry are widely varying. Various applications that support exploration or production operations are illustrated at 616 and 618, and may include various data collection, simulation, interpretation, modeling, forecasting, report generation and other applications and modules. Specific additional examples may include data access management (block 620), asset tracking (block 622), equipment leasing (block 624) and personal contracting (block 626), among others. The herein-described principles may be extended to various use cases involving multiple parties and/or applications, and may be used in some instances to store every minute detail about an oil well, thereby facilitating easy traceability.

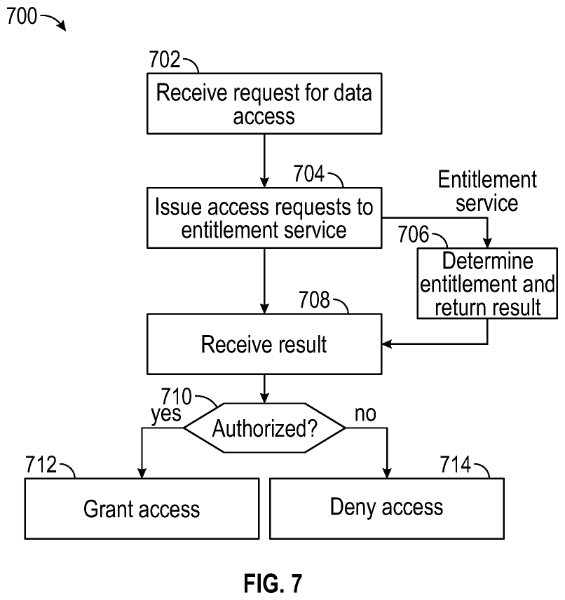

FIG. 7, for example, illustrates an example sequence 700 of operations for authorizing data access by an application in environment 602. In response to receiving a request for data access (block 702), an access request may be issued to the entitlement service (block 704), e.g., using a requesting user's credentials, and the entitlement service may determine entitlement and return a result (block 706). The result may be received (block 708) and a determination may be made as to whether the access request is authorized (block 710). If the result indicates the request is authorized, access may be granted (block 712), and if not, access may be denied (block 714). If granted, the data may be provided in some embodiments with the result, or otherwise may be used to access the data from another source. If denied, appropriate functionality may be used to handle the denied access.

Embodiments consistent with the invention may therefore be used to enable a secured or permissioned blockchain-leveraging entitlement service. Further, some embodiments may improve the performance of a contract validation process as a fewer number of peer nodes may be used to validate as compared to many traditional blockchain frameworks where each node runs validation.

Further, in some embodiments, the aforementioned framework may be extended and used to implement client-specific services to enables clients to transact with their own clients. Clients in some embodiments may, for example, leverage the framework to create a new decentralized energy trading platform, or to manage and execute their own personal contracts (e.g., as represented by block 624 of FIG. 6).

It will be appreciated that data contracting in the oil and gas industry can be complex, with lengthy and confusing agreements. Though companies are generally moving towards digital contracts, it is generally desirable to manage, secure and execute those contracts using one party. For example, in production management, when there is one party central to the process and dealing with multiple parties then all contracting is generally managed by this central party. Embodiments consistent with the invention therefore utilize decentralized data contracting using a blockchain framework to reduce the dependency of a centralized system by distributing the responsibility among peer nodes and increasing operational visibility for clients. Such a solution in some embodiments may also provide an ability to detect if any node gets compromised.

### Hardware and Software Environment

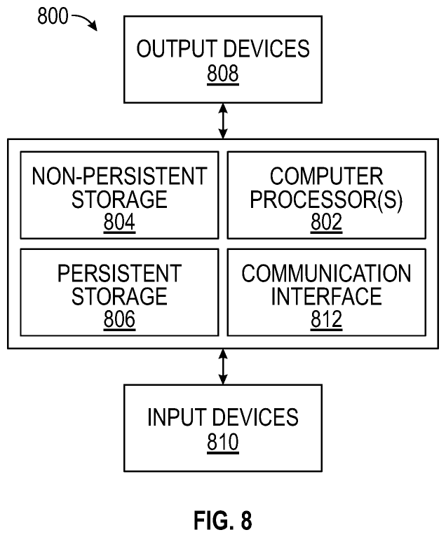

Embodiments may be implemented on a computing system. Any combination of mobile, desktop, server, router, switch, embedded device, or other types of hardware may be used. For example, as shown in FIG. 8, the computing system 800 may include one or more computer processors 802, non-persistent storage 804 (e.g., volatile memory, such as random access memory (RAM), cache memory), persistent storage 806 (e.g., a hard disk, an optical drive such as a compact disk (CD) drive or digital versatile disk (DVD) drive, a flash memory, etc.), a communication interface 812 (e.g., Bluetooth interface, infrared interface, network interface, optical interface, etc.), and numerous other elements and functionalities.

The computer processor(s) 802 may be an integrated circuit for processing instructions. For example, the computer processor(s) may be one or more cores or micro-cores of a processor. The computing system 800 may also include one or more input devices 810, such as a touchscreen, keyboard, mouse, microphone, touchpad, electronic pen, or any other type of input device.

The communication interface 812 may include an integrated circuit for connecting the computing system 800 to a network (not shown) (e.g., a local area network (LAN), a wide area network (WAN) such as the Internet, mobile network, or any other type of network) and/or to another device, such as another computing device.

Further, the computing system 800 may include one or more output devices 808, such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) 802, non-persistent storage 804, and persistent storage 806. Many different types of computing systems exist, and the aforementioned input and output device(s) may take other forms.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments.

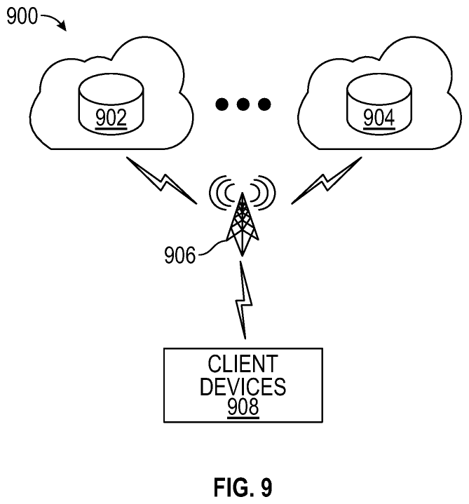

The computing system 800 in FIG. 8 may be connected to or be a part of a network, such as the network 906 described by system 900 of FIG. 9. For example, as shown in FIG. 9, the network 906 may include multiple nodes (e.g., node X 902, node Y 904). Each node may correspond to a computing system, such as the computing system shown in FIG. 8, or a group of nodes combined may correspond to the computing system shown in FIG. 8. By way of an example, embodiments may be implemented on a node of a distributed system that is connected to other nodes. By way of another example, embodiments may be implemented on a distributed computing system having multiple nodes, where each portion of the embodiment may be located on a different node within the distributed computing system. Further, one or more elements of the aforementioned computing system 800 may be located at a remote location and connected to the other elements over a network.

Although not shown in FIG. 9, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X 902, node Y 904) in the network 906 may be configured to provide services for a client device 908. For example, the nodes may be part of a cloud computing system. The nodes may include functionality to receive requests from the client device 808 and transmit responses to the client device 908. The client device 908 may be a computing system, such as the computing system shown in FIG. 8. Further, the client device 1008 may include and/or perform all or a portion of one or more embodiments.

The computing system or group of computing systems described in FIGS. 8 and 9 may include functionality to perform a variety of operations disclosed herein. For example, the computing system(s) may perform communication between processes on the same or different system. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

The above description of functions present only a few examples of functions performed by the computing system of FIG. 8 and the nodes and/or client device in FIG. 9. Other functions may be performed using one or more embodiments.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A computer-implemented method, comprising:
receiving a data access request at a cloud-based collaboration environment; and
processing the data access request with a blockchain-based entitlement service resident in the cloud-based collaboration environment to grant or deny access to the requested data based upon a contract represented in a blockchain managed by the blockchain-based entitlement service.

2. The method of claim 1, wherein the blockchain-based entitlement service is distributed among a plurality of peer nodes in the cloud-based collaboration environment.

3. The method of claim 1, wherein the blockchain-based entitlement service is resident in a distributed blockchain framework.

4. The method of claim 3, wherein the blockchain framework further includes a peer service configured to store transactions and digital contracts, the method further comprising executing a digital contract on a transaction using the peer service.

5. The method of claim 4, further comprising endorsing and committing transactions with the peer service.

6. The method of claim 4, wherein the blockchain framework further includes an application software development kit functioning as a client library, the method further comprising performing transactions within the cloud-based collaboration environment using the application software development kit.

7. The method of claim 4, wherein the blockchain framework further includes an ordering service configured to validate whether endorsed results have been received from a plurality of peer nodes and execute transactions once validation is complete.

8. The method of claim 4, wherein the blockchain framework further includes a membership/entitlement service configured to authenticate, authorize and manage identities and channels.

9. The method of claim 1, further comprising, in the blockchain-based entitlement service:
receiving a digitally signed transaction;
forwarding the digitally signed transaction to a plurality of peer nodes;
in each peer node, validating a digital signature, executing a digital contract setup for the transaction to generate simulation results, endorsing the simulation results and returning the endorsed simulation results;
receiving the validated endorsed results from the plurality of peer nodes and sending the validated endorsed results to an ordering service;
in the ordering service, validating the validated endorsed results, executing one or more transactions and generating a block;
broadcasting the block to the plurality of peer nodes; and
in each peer node, committing and adding the block to a blockchain of the peer node.

10. An apparatus, comprising:
at least one processing unit; and
program code configured upon execution by the at least one processing unit to receive a data access request at a cloud-based collaboration environment and process the data access request with a blockchain-based entitlement service resident in the cloud-based collaboration environment to grant or deny access to the requested data based upon a contract represented in a blockchain managed by the blockchain-based entitlement service.

11. The apparatus of claim 10, wherein the blockchain-based entitlement service is distributed among a plurality of peer nodes in the cloud-based collaboration environment.

12. The apparatus of claim 10, wherein the blockchain-based entitlement service is resident in a distributed blockchain framework.

13. The apparatus of claim 12, wherein the blockchain framework further includes a peer service configured to store transactions and digital contracts, the program code further configured to execute a digital contract on a transaction using the peer service.

14. The apparatus of claim 13, wherein the program code is further configured to endorse and commit transactions with the peer service.

15. The apparatus of claim 13, wherein the blockchain framework further includes an application software development kit functioning as a client library, the program code further configured to perform transactions within the cloud-based collaboration environment using the application software development kit.

16. The apparatus of claim 13, wherein the blockchain framework further includes an ordering service configured to validate whether endorsed results have been received from a plurality of peer nodes and execute transactions once validation is complete.

17. The apparatus of claim 13, wherein the blockchain framework further includes a membership/entitlement service configured to authenticate, authorize and manage identities and channels.

18. The apparatus of claim 10, wherein the blockchain-based entitlement service is further configured to:
receive a digitally signed transaction;
forward the digitally signed transaction to a plurality of peer nodes;
in each peer node, validate a digital signature, execute a digital contract setup for the transaction to generate simulation results, endorse the simulation results and return the endorsed simulation results;
receive the validated endorsed results from the plurality of peer nodes and send the validated endorsed results to an ordering service;
in the ordering service, validate the validated endorsed results, execute one or more transactions and generate a block;
broadcast the block to the plurality of peer nodes; and
in each peer node, commit and add the block to a blockchain of the peer node.

19. A program product, comprising:
a computer readable medium; and
program code stored on the computer readable medium and configured upon execution by at least one processing unit to receive a data access request at a cloud-based collaboration environment and process the data access request with a blockchain-based entitlement service resident in the cloud-based collaboration environment to grant or deny access to the requested data based upon a contract represented in a blockchain managed by the blockchain-based entitlement service.
